(19) United States
(12) Patent Application Publication
(10) Pub. No.: US 2022/0414939 A1
(43) Pub. Date: Dec. 29, 2022

(54) RENDER TARGET COMPRESSION SCHEME COMPATIBLE WITH VARIABLE RATE SHADING

(71) Applicant: Advanced Micro Devices, Inc., Santa Clara, CA (US)

(72) Inventors: Pazhani Pillai, Boxborough, MA (US); Christopher J. Brennan, Boxborough, MA (US)

(73) Assignee: Advanced Micro Devices, Inc., Santa Clara, CA (US)

(21) Appl. No.: 17/361,140

(22) Filed: Jun. 28, 2021

(51) Int. Cl. G06T 9/00; G06T 15/20; G06T 15/00; G06T 1/60

(52) U.S. Cl. CPC G06T 9/00; G06T 15/205; G06T 15/005; G06T 1/60; G06T 2210/08

(57) ABSTRACT

A disclosed technique includes reading, from a compressed render target, a set of unique color values for a coarse pixel, wherein the coarse pixel includes multiple render target pixels; reading, from the compressed render target, pointers to the unique color values for the coarse pixel; and generating colors for the multiple render target pixels based on the unique color values and the pointers.

### BACKGROUND

Three-dimensional (“3D”) graphics processing pipelines perform a series of steps to convert input geometry into a two-dimensional (“2D”) image for display on a screen. Because output images generally include a large amount of data, compression schemes can be useful.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates details of the device of FIG. 1, according to an example;

FIG. 3 is a block diagram showing additional details of the graphics processing pipeline illustrated in FIG. 2;

FIG. 4A is an illustration of rendering operations for a triangle, according to an example;

FIG. 4B illustrates rendering operations for variable rate shading, according to an example;

FIG. 4C illustrates a small portion of a render target buffer, according to an example;

FIG. 5 illustrates operations for a variable rate shading-compatible compression scheme, according to an example;

FIG. 6 is a method for compressing data into a compressed render target buffer, according to an example; and

FIG. 7 is a method for decompressing data from a compressed render target buffer, according to an example.

### DETAILED DESCRIPTION

A disclosed technique includes reading, from a compressed render target, unique color values for a coarse pixel, wherein the coarse pixel includes multiple render target pixels; reading, from the compressed render target, pointers to the unique color values for the coarse pixel; and generating colors for the multiple render target pixels based on the unique color values and the pointers.

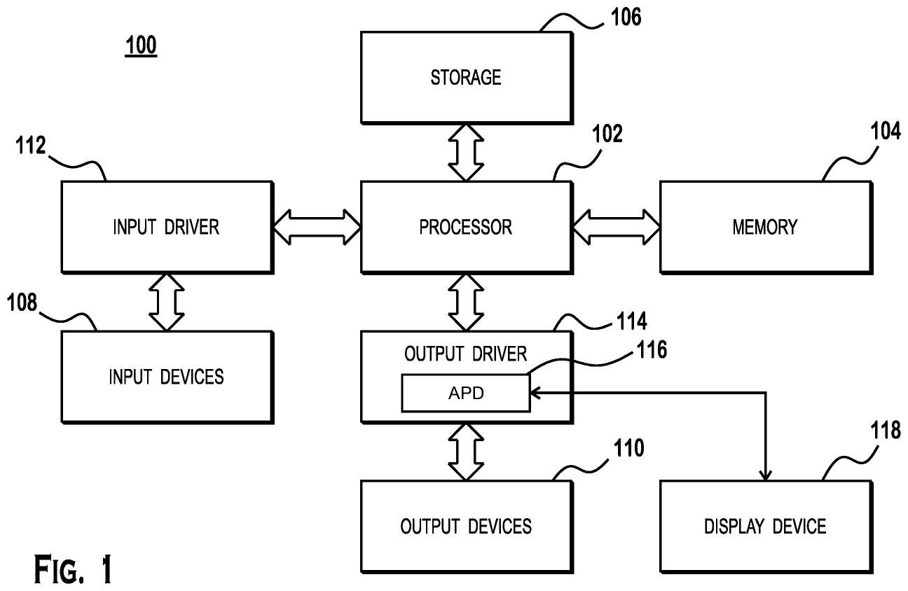

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118, which, in some examples, is a physical display device or a simulated device that uses a remote display protocol to show output. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm performs the functionality described herein.

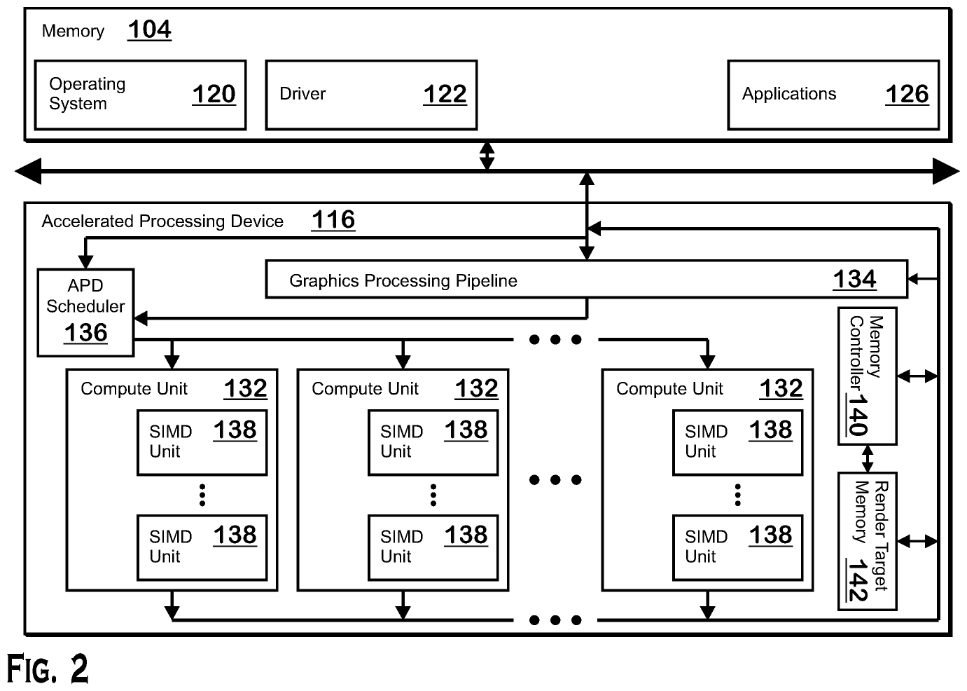

FIG. 2 illustrates details of the device 100 and the APD 116, according to an example. The processor 102 (FIG. 1) executes an operating system 120, a driver 122, and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

The graphics processing pipeline 134 is capable of performing rendering operations in a mode referred to as variable rate shading. In variable rate shading, each pixel shader work-item is capable of performing a shading operation to determine color for multiple render target pixels. Without variable rate shading, each work-item generates a color for at most one render target pixel. The “render target” is the ultimate destination for the results of the render operations. An example render target is the frame buffer, which stores pixel data for output to a screen.

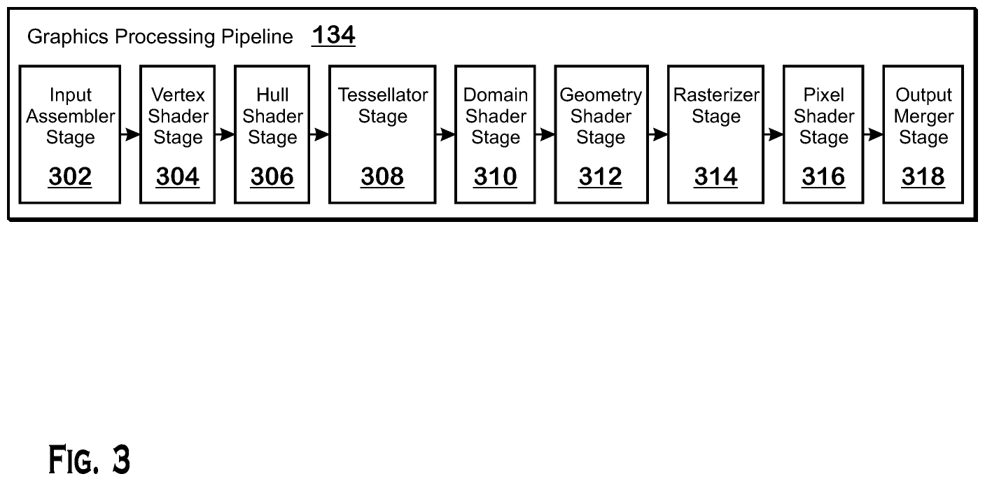

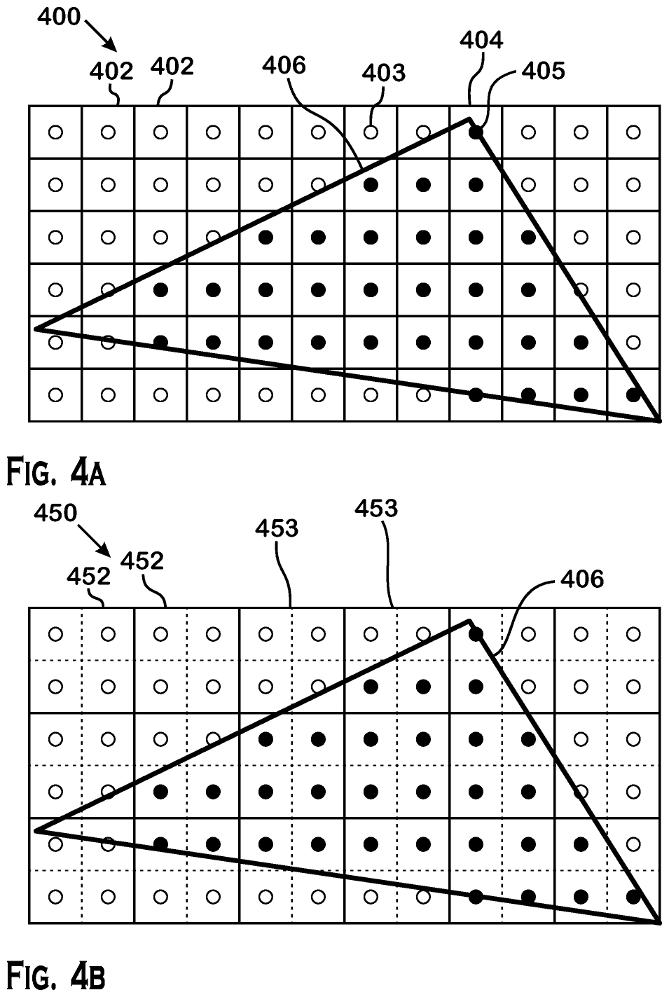

FIG. 4A is an illustration of rendering operations for a triangle 406, according to an example. Several render target pixels 402 are illustrated within the vicinity of the triangle 406. The rasterizer stage 314 determines which of these pixels 402 is covered by the triangle 406 (shown as covered pixels 404) and generates fragments for each such pixel for fragment shading by the pixel shader stage 316. In some examples, the rasterizer stage 314 determines which pixels 402 are covered based on a sample position for the pixel 402. An uncovered sample position 403 is a sample position external to the triangle 406 and a covered sample position 405 is a sample position that is internal to the triangle. Thus a pixel 402 whose sample position is internal to the triangle 406 is considered covered and a pixel whose sample position is external to the triangle 406 is considered not covered. Each work-item executing in the pixel shader stage 316 performs shading operations for one such covered pixel 404.

FIG. 4B illustrates rendering operations for variable rate shading, according to an example. In FIG. 4B, the same triangle 406 is shown with several coarse pixels 452. Each coarse pixel 452 is the size of four render target pixels 402. Note that although a specific coarse pixel size is shown (2x2), it is possible for the variable rate shading to perform shading operations for pixels of different shapes and sizes such as 2x1, 1x2, 1x1, or other pixel sizes. Note also that although it is shown in FIG. 4B that the same pixel size is used for a single triangle 406, it is possible for the pixel size and/or shape to vary within a triangle and within a render target.

In FIG. 4B, the rasterizer stage 314 has determined which of the coarse pixels 452 are covered by the triangle 406. The coarse pixels with some coverage are covered coarse pixels 453, and coarse pixels with no coverage are uncovered coarse pixels 452. Each pixel shader work-item determines a color for a single coarse pixel, meaning that in the illustrated example, the pixel shader workload is reduced by approximately a factor of four (although coarse pixels with low coverage will have a smaller reduction due to the fact that such coarse pixels correspond to fewer than four render target pixels).

Each coarse pixel is shown with four samples (covered samples 454 or 456). These samples represent sample positions for pixels in a similar manner as with respect to multi-sampled fragments in a technique that does not use variable rate shading. The samples are illustrated simply for ease of explanation, as the sample positions correspond to the smaller pixel positions of FIG. 4A. However, it should be understood that it is possible for coarse pixels in variable rate shading to have a varying number of samples at varying locations, and that the number of samples for each coarse pixel does not have to equal the number of render target pixels within that coarse pixel. In some modes of operation, the rasterizer stage 314 determines whether coarse pixels are covered and which samples are covered for such coarse pixels. In some modes of operation, the pixel shader determines a single color to apply for each sample of a coarse pixel. In some modes of operation, the output merger stage 318 “expands” the coarse pixels to be stored into the render target buffer (the memory location at which the render target is located). “Expanding” the coarse pixels means converting the coarse pixels into render target pixels according to the size, shape, and position of the coarse pixels. In an example, the output merger stage 318 generates render target pixels for each render target pixel “within” a coarse pixel and combines those render target pixels to the render target. The term “combines” means performs operations, such as a depth test, blending, or other operations, to either discard, overwrite, or blend the render target pixels into the data that is already stored in the render target.

FIG. 4C illustrates a small portion of a render target buffer 470, according to an example. The render target buffer 470 includes a number of render target pixels 472, each of which includes a color, indicated with a label including the letter C and a number. Render target pixels 472 including having the same label have the same color. It should be understood that it is possible for variable rate shading operations to result in the same color being generated for multiple render target pixels, and that the render target buffer 470 stores indicates that each such render target pixel has that particular color. For example, the example render target buffer 470 includes indications that several pixels (e.g., pixel 472(1), 472(2), 472(3), and 472(4) have color C1).

A compression scheme is disclosed herein that is suitable for use with data generated via variable rate shading. Note that although this compression scheme is suitable for data generated via variable rate shading, it is not necessary for these compression techniques to be used with data generated by variable rate shading.

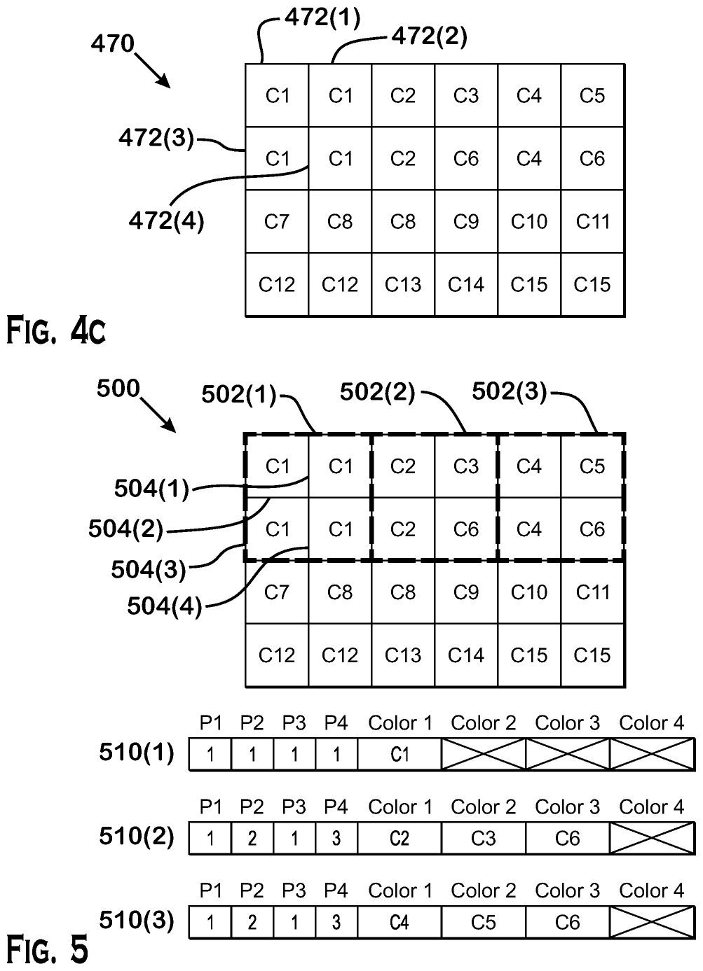

FIG. 5 illustrates operations for a variable rate shading-compatible compression scheme, according to an example. The example of FIG. 5 uses the data from FIG. 4C, but it should be understood that the specific colors shown are examples used to illustrate the technique.

The illustrated technique compresses data for a render target buffer by eliminating duplicate color information. More specifically, for each coarse pixel 502, which is larger than a fine pixel 504 (render target pixel), a compressed data unit 510 stores one or more items of color information (shown in FIG. 5 as “color X” where “X” is a number) and one or more color information pointers (shown in FIG. 5 as “PX” where “X” is a number). Each color information pointer references one of the items of color information. The number of bits in each color information pointer is significantly less than the number of bits in each item of color information. The color information pointers correspond to render target pixels. Thus, the compressed data unit 510 includes pointers for each pixel to color information. Using pointers in this manner removes the total amount of data that needs to be read from the render target buffer in order to access that information. Note that in this form of compression, the actual amount of storage in the render target buffer is not necessarily smaller than simply storing raw data, since sufficient memory to store unique colors for each pixel position is allocated. The compression provides the benefit of requiring less data to be read from the render target buffer during processing, which reduces memory bandwidth.

In the example of FIG. 5, three compressed data units are shown. For the pointers, the number shown indicates one of the colors of the compressed data item. An X through a color means that the allocated space for that color is not used for the corresponding compressed data unit 502.

Coarse pixel 502(1) corresponds to compressed data unit 510(1). Since all pixels 504 of coarse pixel 502(1) have the same color (C1), the pointer for each pixel includes a pointer to the color slot (color 1) that stores the color value C1, as shown. Note, the values in the pointers indicate one of the color slots of the compressed data unit 510 by number.

Coarse pixel 502(2) corresponds to compressed data unit 510(2). Coarse pixel 502(2) has three unique color values: C2, C3, and C6. The compressed data unit 510(2) thus includes these three colors in color slot 1, color slot 2, and color slot 3, respectively. The color pointers indicate, for pixels 1 and 3 (the two left pixels), color slot 1 (C2), for pixel 2 (the top right pixel), color slot 2 (C3), and for pixel 4 (the bottom right pixel), color slot 3 (C6).

Coarse pixel 502(3) corresponds to compressed data unit 510(3). Coarse pixel 502(3) also includes three unique color values: C4, C5, and C6. The compressed data unit 510(3) thus includes these three colors in color slots 1, 2, and 3, respectively. The color pointers indicate, for pixels 1 and 3, color slot 1 (C4), for pixel 2, color slot 2 (C3), and for pixel 4, color slot 3 (C6).

The compressed render target buffer includes a plurality of the compressed data units 510. In some examples, the compressed render target buffer includes a sufficient number of compressed data units 510 to cover the entire area of the render target (for example, a sufficient number of compressed data units 510 to store pixel information for an area having a specific resolution and thus a specific number of pixels).

In summary, a compressed render target includes a number of compressed data units 510. Each compressed data unit stores information for multiple pixels. Within a particular compressed data unit 510, duplicated values are omitted by storing unique colors once and storing pointers to those colors. In some examples, the entire render target area is represented by compressed data units 510, while in other examples, areas of the render target corresponding to coarse compression pixels that include at least one duplicated color are represented as compressed data units 510, and areas of the render target corresponding to coarse compression pixels that include all unique colors are represented as uncompressed data.

Although the example described with respect to FIG. 5 shows color values stored on a pixel-by-pixel basis, it is possible for each compressed data unit 510 to store colors on a sample-by-sample basis. More specifically, some render targets have multiple color samples per pixel. In such situations, the compressed data units 510 include sample color data items and sample color pointers. Each sample color data item stores a color value that is unique for that compressed data unit 510. Each sample color pointer points to one of the unique sample color values, and thereby associated one of the samples of the render target to one of the unique colors of the compressed data units 510.

The coarse pixels 502 of the compression scheme are not necessarily aligned with the coarse pixels used in a variable rate shading technique. In some examples, the compression coarse pixels 502 have the same shape and size throughout the compressed render target. A benefit of the compression scheme is that in the situation that variable rate shading is used, the duplicated colors produced by lower shading rates can be removed from the compressed render target.

In some examples, a client reads the compressed render target by obtaining one or more of the compressed data units 510 and decompressing that data. In an example, a client obtains each of the unique colors and each of the pointers of a compressed data unit 510 and determines the colors for each of the represented pixels by determining the color pointed to by each of the pointers. The amount of data that needs to be read is less than the situation in which all pixel locations or sample locations have their color data stored explicitly.

In some examples, the client includes a pixel shader which reads a texture (where the texture stores the result of a render—in other words, the render target is subsequently used as a texture) or a color block of the output merger stage 318, which performs color operations on a render target. The color block stores colors into the compressed render target, compressing those colors as the values are stored. Because the color block sometimes needs to read colors from the compressed render target (for example, for blending operations in which a fragment that arrives at the output merger stage 318 from the earlier portions of the graphics processing pipeline 134), the color block sometimes reads the compressed data, decompresses the data, modifies the decompressed data, compresses the modified data, and stores the compressed modified data back into the compressed render target.

In some examples, the client decompresses the compressed data when the client reads the data and compresses the data when the client writes the data. In other examples, a memory controller 140 receives requests to access render target memory 142 (which, in some examples, is a dedicated buffer, is a portion of a general memory of the APD 116, or is a portion of some other memory) and performs compression and decompression for those accesses. More specifically, the memory controller 140 compresses data (e.g., generates the compressed data units 510) for the render target memory 142 when a client (such as the output merger stage 318) writes data to the compressed render target and decompresses data when a client (such as the pixel shader stage 316 or the output merger stage 318) reads data from the compressed render target. Herein, the term “compressor” refers to any entity that performs the compression described herein, such as one of the units of the graphics processing pipeline 134 or the memory controller 140. The term “decompressor” refers to any entity that performs the decompression described herein, such as one of the units of the graphics processing pipeline 134 or the memory controller 140.

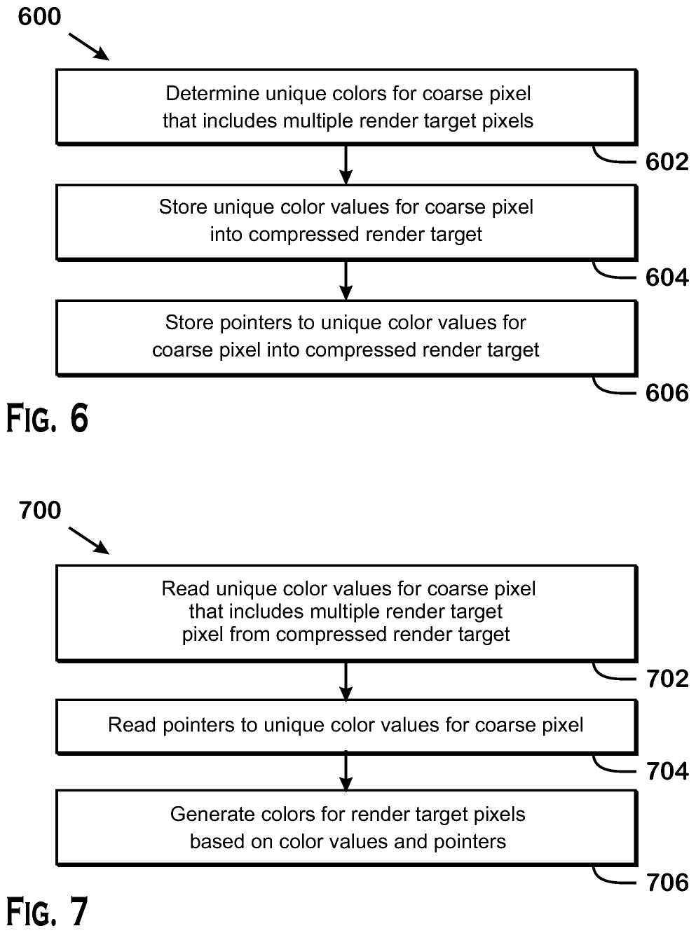

FIG. 6 is a method 600 for compressing data into a compressed render target buffer, according to an example. Although described with respect to the system of FIGS. 1-5, those of skill in the art will understand that any system configured to perform the steps of the method 600 in any technically feasible order falls within the scope of the present disclosure.

At step 602, a compressor determines unique colors for a coarse pixel, where the coarse pixel includes multiple render target pixels. As described elsewhere herein, a render target pixel is a pixel of the render target. The render target is a portion of memory to which the results of the graphics processing pipeline 134 are written. Some examples of a render target include a frame buffer that stores pixel data for output to a screen, or a different memory that stores an image for other uses (e.g., as a texture). A coarse pixel includes multiple pixels of the render target. In some examples, the multiple pixels of the coarse pixel include adjacent pixels. In some examples, the pixels form a square or rectangular pattern. In some examples, the pixels are in a 2x1 configuration (2 in a row), a 1x2 configuration (2 in a column), a 2x2 configuration (a 2x2 square of pixels), or in any other configuration. Unique colors for a coarse pixel are the color values for the pixels (or for the samples if pixels have multiple samples and each sample is permitted to have different colors) without duplicates included. For example, if two pixels within the coarse pixel have the same color (color 1), a third pixel has another color (color 2), and a fourth pixel has yet another color (color 3), then the unique colors are color 1, color 2, and color 3.

At step 604, the compressor stores the unique color values for the coarse pixel into the compressed render target. In some examples, the color values are stored as part of a compressed data unit 510 as described elsewhere herein. At step 606, the compressor stores pointers to the unique color values into the compressed render target. The compressor stores one pointer for each sample or render target pixel within the coarse pixel. In an example, if there are four render target pixels in a coarse pixel and each render target pixel is not multi-sampled, then the compressed data unit 510 stores four pointers, one for each pixel. Each pointer references one of the unique colors, thereby associating a unique color with a pixel. In another example, the coarse pixel has two render target pixels, each of which has four samples. In this example, there are four pointers, one for each sample, and each pointer references one of the unique colors.

A variation to the above technique for performing compression is now described. In the variation, the compressor stores unique color values and pointers for each coarse pixel into a cache or other memory. More specifically, in response to the pixel shader stage 316 outputting a coarse shaded pixel, a cache stores the unique colors within the pixel and pointers for each sample of the coarse pixel to the colors. Subsequently, when modifications occur to that pixel (e.g., when the pixel shader stage 316 outputs another shaded coarse pixel for the sample location), the cache modifies the unique colors and pointers as necessary. In other words, the cache stores data as compressed coarse pixels, storing pointers and unique colors for those coarse pixels, rather than as unique colors and pointers for render target pixels. When data is written to the cache in this manner, it is possible to update color values and not pointers if data for an incoming coarse pixel has the same pixel size and coverage as the data in the cache. In an example, a first coarse pixel is rendered and stored to the cache as one unique color and pointers for each sample. Subsequently, a second coarse pixel is rendered for the same location within the render target and having the same coverage as the first coarse pixel. In this example, the cache updates the color value and not the pointers.

One benefit of storing the compressed data in a cache is that such storing allows engine optimizations to be performed. In an example, if the underlying surface was rendered at a 2x2 variable shading rate, and an incoming coarse fragment from the pixel shader stage 316 is also rendered at a 2x2 rate, and blending is occurring, then it is possible to perform the blend operation only once since there is only one unique color across the 2×2 pixels in the cache, and one unique incoming color. If the data were not stored in the cache in this compressed format, then additional work would need to be performed, such as performing four blend operations or checking that there is one unique color in the cache every time the cache is read. Note that although this alternative example has been described in the context of a cache, the technique can be implemented in a memory other than a cache.

FIG. 7 is a method 700 for decompressing data from a compressed render target buffer, according to an example. Although described with respect to the system of FIGS. 1-5, those of skill in the art will understand that any system configured to perform the steps of the method 700 in any technically feasible order falls within the scope of the present disclosure.

At step 702, a decompressor reads unique color values for a coarse pixel that includes multiple render target pixels from a compressed render target. At step 704, the decompressor reads pointers to the unique color values for the coarse pixel. At step 706, the decompressor generates colors for the render target pixels based on the color values and the pointers. As described elsewhere herein, the pointers reference one of the unique color values and are associated with a pixel or sample.

Generating the colors thus includes determining that the sample or pixel has the color value pointed to by the associated pointer.

It should be understood that many variations are possible based on the disclosure herein. Although features and elements are described above in particular combinations, each feature or element can be used alone without the other features and elements or in various combinations with or without other features and elements. In some examples, it is possible to apply an additional compression technique other than the technique described to the pixel data. In such examples, the compression technique described herein is one compression layer, with one or more additional compression layers applied to the data as well.

The various functional units illustrated in the figures and/or described herein (including, but not limited to, the processor 102, the input driver 112, the input devices 108, the output driver 114, the output devices 110, the APD 116, the APD scheduler 136, the graphics processing pipeline 134, the memory controller 140, the render target memory 142, the compute units 132, the SIMD units 138, and each stage of the graphics processing pipeline 134 illustrated in FIG. 3) may be implemented as a general purpose computer, a processor, a processor core, or fixed function circuitry, as a program, software, or firmware, stored in a non-transitory computer readable medium or in another medium, executable by a general purpose computer, a processor, or a processor core, or as a combination of software executing on a processor or fixed function circuitry. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language

(HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
reading, from a compressed render target, a set of one or more unique color values for a coarse pixel, wherein the coarse pixel includes multiple render target pixels;
reading, from the compressed render target, pointers to the unique color values for the coarse pixel; and
generating colors for the multiple render target pixels based on the unique color values and the pointers.

2. The method of claim 1, wherein each render target pixel includes multiple samples.

3. The method of claim 2, wherein the pointers include one pointer per sample of the multiple samples.

4. The method of claim 3, wherein generating the colors includes setting, as a color for each sample, a color value pointed to by the pointer for the sample, wherein the color value is included in the unique color values for the coarse pixel.

5. The method of claim 1, wherein each render target pixel of the multiple render target pixels includes one sample.

6. The method of claim 5, wherein the pointers include one pointer per pixel of the multiple render target pixels.

7. The method of claim 6, wherein generating the colors includes setting, as a color for each pixel, a color value pointed to by the pointer for the pixel, wherein the color value is included in the unique color values for the coarse pixel.

8. The method of claim 1, further comprising:
modifying one or more of the colors to generate modified colors; and
compressing the modified colors to generate compressed modified colors.

9. The method of claim 8, wherein compressing the modified colors includes:
storing unique colors for the coarse pixel into the compressed render target; and
storing pointers to the unique colors for the multiple render target pixels into the compressed render target.

10. The method of claim 1, wherein:
a cache stores compressed pixel data at a coarse shading rate, including data for a render target location corresponding to the coarse pixel; and
the method further comprises:
performing a shading operation at a shading rate corresponding to the coarse pixel to generate a unique color value;
blending the unique color value with a unique color value stored in the cache for the coarse pixel to generate a blended unique color value at a coarse shading rate; and
storing the blended unique color value into the cache.

11. The method of claim 1, wherein the compressed render target stores compressed data using multiple compression layers, wherein one compression layer includes compression in which unique colors and pointers are stored.

12. A system, comprising:
a decompressor circuit configured to:
read, from a compressed render target, unique color values for a coarse pixel, wherein the coarse pixel includes multiple render target pixels;
read, from the compressed render target, pointers to the unique color values for the coarse pixel; and
generate colors for the multiple render target pixels based on the unique color values and the pointers.

13. The system of claim 12, wherein each render target pixel includes multiple samples.

14. The system of claim 13, wherein the pointers include one pointer per sample of the multiple samples.

15. The system of claim 14, wherein generating the colors includes setting, as a color for each sample, a color value pointed to by the pointer for the sample, wherein the color value is included in the unique color values for the coarse pixel.

16. The system of claim 12, wherein each render target pixel of the multiple render target pixels includes one sample.

17. The system of claim 16, wherein the pointers include one pointer per pixel of the multiple render target pixels.

18. The system of claim 17, wherein generating the colors includes setting, as a color for each pixel, a color value pointed to by the pointer for the pixel, wherein the color value is included in the unique color values for the coarse pixel.

19. The system of claim 12, further comprising:
a compressor configured to compress modified colors generated based on the colors.

20. The system of claim 19, wherein compressing the modified colors includes:
storing unique colors for the coarse pixel into the compressed render target; and
storing pointers to the unique colors for the multiple render target pixels into the compressed render target.

21. A system comprising:
a compressor circuit configured to:
store unique colors for a coarse pixel into a memory,
wherein the coarse pixel corresponds to an area including multiple pixels of a compressed render target.

22. The system of claim 21, wherein the unique colors include no duplicate color values.

23. The system of claim 21, wherein:
prior to the storing, the compressed render target stores a set of one or more original unique colors for the coarse pixel and a set of one or more original pointers that point to the one or more unique colors

24. The system of claim 23, wherein:
storing the unique colors comprises:
receiving rendered data for the coarse pixel, the rendered data including the unique colors;
in response to the rendered data being rendered at a first shading rate that is the same as a second shading rate at which the original unique colors were generated, overwriting the one or more original unique colors.

25. The system of claim 21, wherein the compressor circuit is further configured to:
store pointers to the unique colors for the multiple render target pixels into the compressed render target.

26. The system of claim 25, wherein each pointer associates a coarse pixel sample with a unique color of the unique colors.
